(19) United States
(12) Patent Application Publication
(10) Pub. No.: US 2017/0054204 A1
(43) Pub. Date: Feb. 23, 2017

(54) V2X ANTENNA SYSTEMS

(71) Applicant: Laird Technologies, Inc., Earth City, MO (US)

(72) Inventors: Raghavendar Changalvala, Troy, MI (US); Panamalai Gururaj, Holly, MI (US); Ayman Duzdar, Holly, MI (US); Cheikh T. Thiam, Grand Blanc, MI (US); Imre Magyar, JR., Overland Park, KS (US); Joseph M. Combi, Grand Blanc, MI (US); Hasan Yasin, Grand Blanc, MI (US)

(21) Appl. No.: 15/243,137

(22) Filed: Aug. 22, 2016

Related U.S. Application Data
(60) Provisional application No. 62/208,042, filed on Aug. 21, 2015.

(51) Int. Cl. H01Q 1/32; H01Q 1/42; H01Q 1/22; H01Q 1/24

(52) U.S. Cl. CPC H01Q 1/3291; H01Q 1/241; H01Q 1/42; H01Q 1/2291; H01Q 1/3275

(57) ABSTRACT

Disclosed are exemplary embodiments of V2X antenna systems. In an exemplary embodiment, an integrated vehicular antenna system generally includes a V2X smart antenna module and a telematics communication module. The antenna system may be configured to enable a vehicle to have V2X communications. In another exemplary embodiment, an V2X smart antenna assembly generally includes one or more cellular antennas, a satellite navigation antenna, a satellite radio antenna, one or more DSRC antennas, and one or more terrestrial antennas. The V2X smart antenna assembly may also include a satellite navigation system receiver and a V2X RF transceiver.

### CROSS-REFERENCE TO RELATED APPLICATION

This patent application claims the benefit of and priority to U.S. Provisional Patent Application No. 62/208,042 filed Aug. 21, 2015. The entire disclosure of the above application is incorporated herein by reference.

### FIELD

The present disclosure generally relates to V2X antenna systems.

### BACKGROUND

This section provides background information related to the present disclosure which is not necessarily prior art.

Various different types of antennas are used in the automotive industry, including amplitude modulation (AM) and/or frequency modulation (FM) radio antennas, satellite digital audio radio service (SDARS) antennas, global navigation satellite system (GNSS) antennas (e.g., global positioning system (GPS) antennas, etc.), cellular antennas, etc. Automotive antennas may be installed or mounted on an exterior vehicle surface, such as the roof, trunk, or hood of the vehicle to help ensure that the antennas have unobstructed views overhead or toward the zenith. The antennas may be connected (e.g., using one or more RF coaxial cables, etc.) to one or more electronic devices (e.g., a radio receiver, a touchscreen display, a navigation device, a cellular phone, etc.) inside the passenger compartment of the vehicle, such that the antennas are operable for transmitting and/or receiving signals to/from the electronic device(s) inside the vehicle.

### DRAWINGS

The drawings described herein are for illustrative purposes only of selected embodiments and not all possible implementations, and are not intended to limit the scope of the present disclosure.

FIG. 1 is a perspective view of an exemplary two-stage V2X antenna system including a smart antenna module (SAM) and telematics communication module (TCM) according to an exemplary embodiment, where the SAM is shown on top of a vehicle roof while the TCM is underneath the roof below the SAM;

FIG. 2 is a perspective view of the telematics communication module (TCM) shown in FIG. 1;

FIG. 3 is a block diagram showing components of the telematics communication module (TCM) shown in FIGS. 1 and 2;

FIG. 4 is a block diagram showing the components of the telematics communication module (TCM) shown in FIG. 3 and also showing components of the smart antenna module (SAM) shown in FIG. 1;

FIG. 5 is a software architecture block diagram of the telematics communication module (TCM) and the smart antenna module (SAM) shown in FIG. 1;

FIG. 6 is a hardware block diagram of the telematics communication module (TCM) and the smart antenna module (SAM) shown in FIG. 1;

FIG. 7 is another block diagram showing components of the telematics communication module (TCM) shown in FIGS. 1 and 2;

FIG. 8 is a diagram showing an example use of the V2X antenna system shown in FIG. 1;

FIG. 9 is a perspective view of the smart antenna module (SAM) or assembly shown in FIG. 1 without the radome;

FIG. 10 is a top view of the smart antenna assembly shown in FIG. 9;

FIG. 11 is a side view of the smart antenna assembly shown in FIG. 9;

FIG. 12 is a front view of the smart antenna assembly shown in FIG. 9;

FIG. 13 is an exploded perspective view of the smart antenna assembly shown in FIG. 1; and

FIG. 14 is a block diagram showing components of a V2X antenna system that may be connected to the V2X smart antenna assembly shown in FIGS. 9 through 13.

### DETAILED DESCRIPTION

Example embodiments will now be described more fully with reference to the accompanying drawings.

Disclosed herein are exemplary embodiments of V2X smart antenna assemblies or modules that include DSRC or V2X antennas, cellular antennas, and satellite antennas. In such exemplary embodiments, a V2X solution may be integrated or included in a smart antenna assembly, which may provide a user with more versatility in communication.

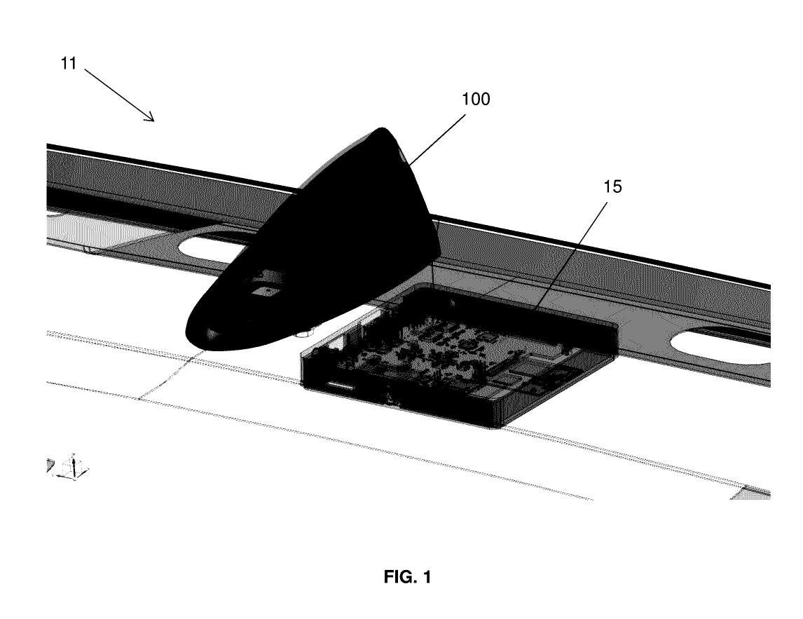

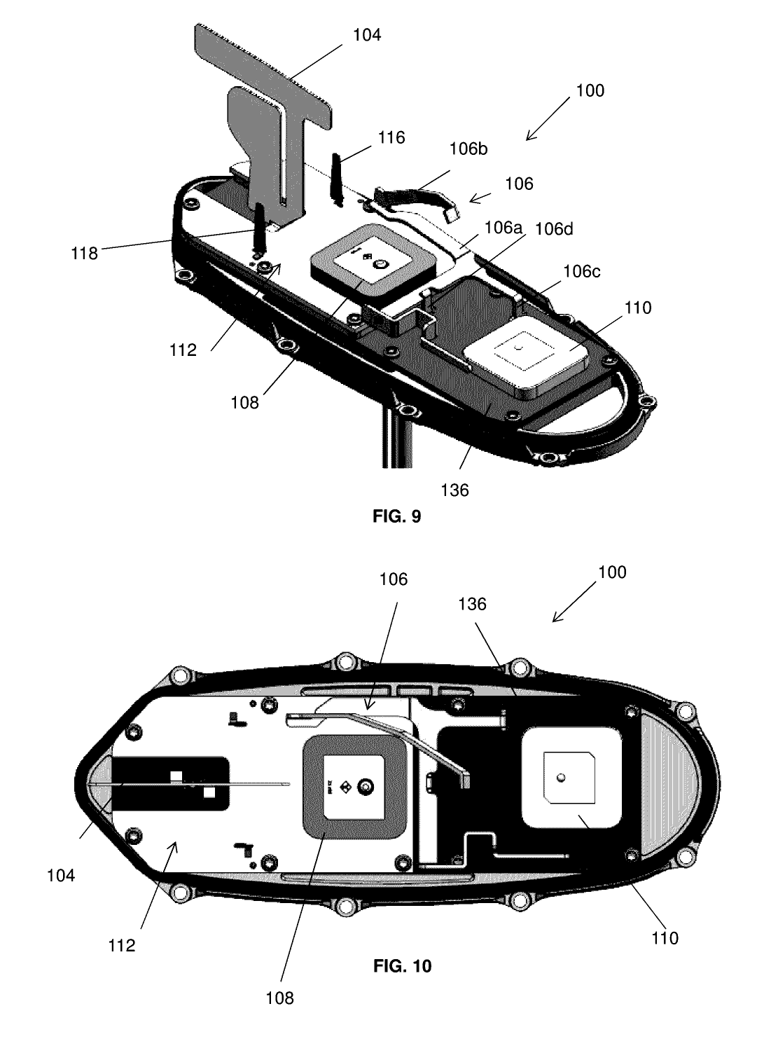

Also disclosed herein for exemplary embodiments, a single or integrated antenna system for a vehicle generally includes V2X functionality or connectivity. The V2X connectivity may allow vehicles to communicate with each other (Vehicle-to-Vehicle (V2V)) and allow vehicles to communicate with infrastructure (Vehicle-to-Infrastructure (V2I)). Also disclosed are exemplary embodiments of V2X smart antenna assemblies or modules (e.g., antenna assembly 100 shown in FIGS. 1 and 9, etc.), which may be used in a single or integrated antenna system (e.g., antenna system 11 shown in FIG. 1, etc.) for a vehicle.

In some exemplary embodiments, a V2X smart antenna assembly or module is a multiband multiple input multiple output (MIMO) vehicular antenna assembly that is configured for installation to a vehicle body wall, such as a vehicle roof, etc. The V2X smart antenna assembly may be operable with one or more cellular signals or frequencies (e.g., Long Term Evolution (LTE), etc.), one or more satellite signals or frequencies (e.g., SDARS, GNSS, GPS, GLONASS, Doppler Orbitography and Radio-positioning Integrated by Satellite (DORIS), BeiDou Navigation Satellite System (BDS), etc.), one or more other signals or frequencies (e.g., dedicated short range communication (DSRC), digital audio broadcasting (DAB), etc.), and/or one or more terrestrial signals (e.g., AM/FM, etc.).

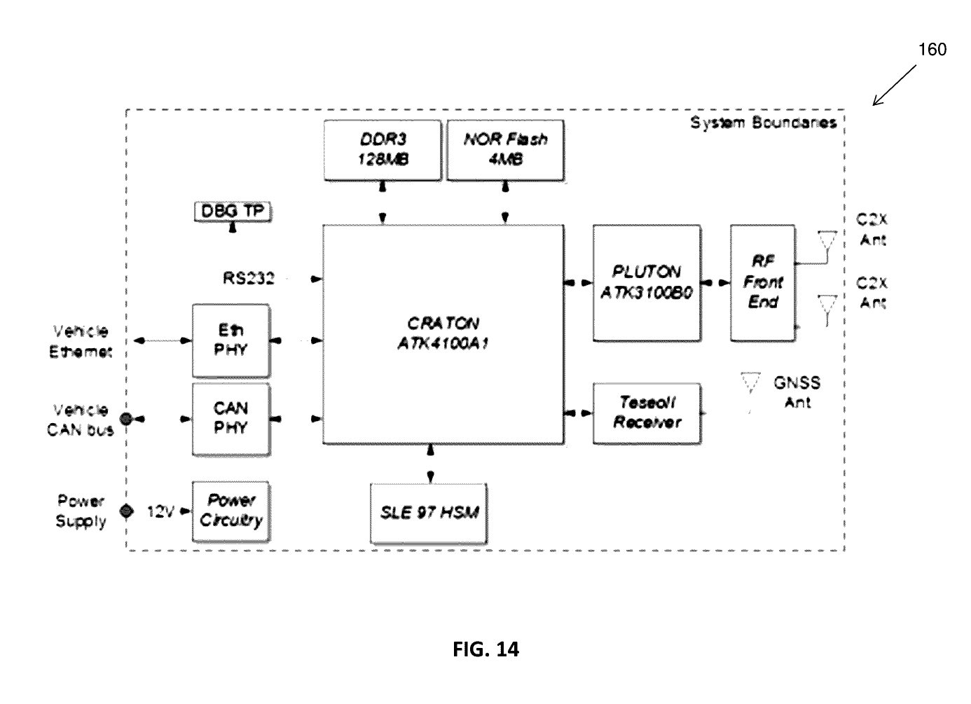

In some exemplary embodiments, the smart antenna assembly or module may be a shark-fin type roof-mount antenna for vehicles. Additionally, the smart antenna assembly may include antennas for DSRC, AM/FM, DAB, LTE, GNSS, satellite radio as well as the V2X radio. In which case, all services for DSRC, AM/FM, DAB, LTE, GNSS, satellite radio, and V2X may thus be located within a single roof-mount antenna system. As such, all of these services may thus be included for a production ready smart antenna assembly in these exemplary embodiments. In addition, the services included in the smart antenna assembly, except V2X and GNSS, may be antennas with an RF output. The V2X antenna may be connected to a V2X system (e.g., the antenna system 160 shown in FIG. 14, etc.). Accordingly, these exemplary embodiments uniquely include all of the above functionalities in the smart antenna assembly.

According to additional aspects of the disclosure, exemplary embodiments are disclosed of an integrated vehicular antenna system (e.g., antenna system 11 shown in FIG. 1, etc.). In exemplary embodiments, the integrated vehicular antenna system comprises a two stage system that includes (1) a V2X smart antenna module (SAM) or assembly (e.g., SAM 100 shown in FIGS. 1 and 9, etc.); and (2) a telematics communication module (TCM) (e.g., TCM 15 shown in FIG. 1 through 8, etc.). The TCM may also be referred to herein as an in-vehicle connectivity module or a data pipe module. The SAM and the TCM may be in communication with or connected to each other over an Ethernet interface.

The SAM may be configured to enable communication between the vehicle and environment (Vehicle-to-Infrastructure (V2I)) and/or between the vehicle and another vehicle (Vehicle-to-Vehicle (V2V)). The TCM or in-vehicle connectivity module may be configured to provide internet access service (e.g., wireless connectivity, internet browsing capability, etc.) to passengers in the vehicle.

The integrated vehicular antenna system may be configured as a single system that handles various wireless and wired sub-systems to enable a vehicle to have V2X communications, internet connectivity via Wi-Fi or Ethernet, and Bluetooth based vehicle control/monitoring. The integrated vehicular antenna system may be configured such that it is relatively easy to install on a vehicle.

The SAM may generally include at least one or more of a cellular antenna configured to be operable for receiving and transmitting LTE signals, a DSRC antenna configured to be operable for receiving DSRC signals, a satellite antenna configured to be operable for receiving satellite radio signals, a satellite antenna configured to be operable for receiving satellite navigation signals, and/or an antenna configured to operable for receiving terrestrial signals. The SAM may be operable with one or more cellular signals or frequencies (e.g., LTE, etc.), one or more satellite signals or frequencies (e.g., SDARS, GNSS, GPS, GLONASS, DORIS, BDS, etc.), one or more other signals or frequencies (e.g., DSRC, DAB, etc.), and/or one or more terrestrial signals (e.g., AM/FM, etc.).

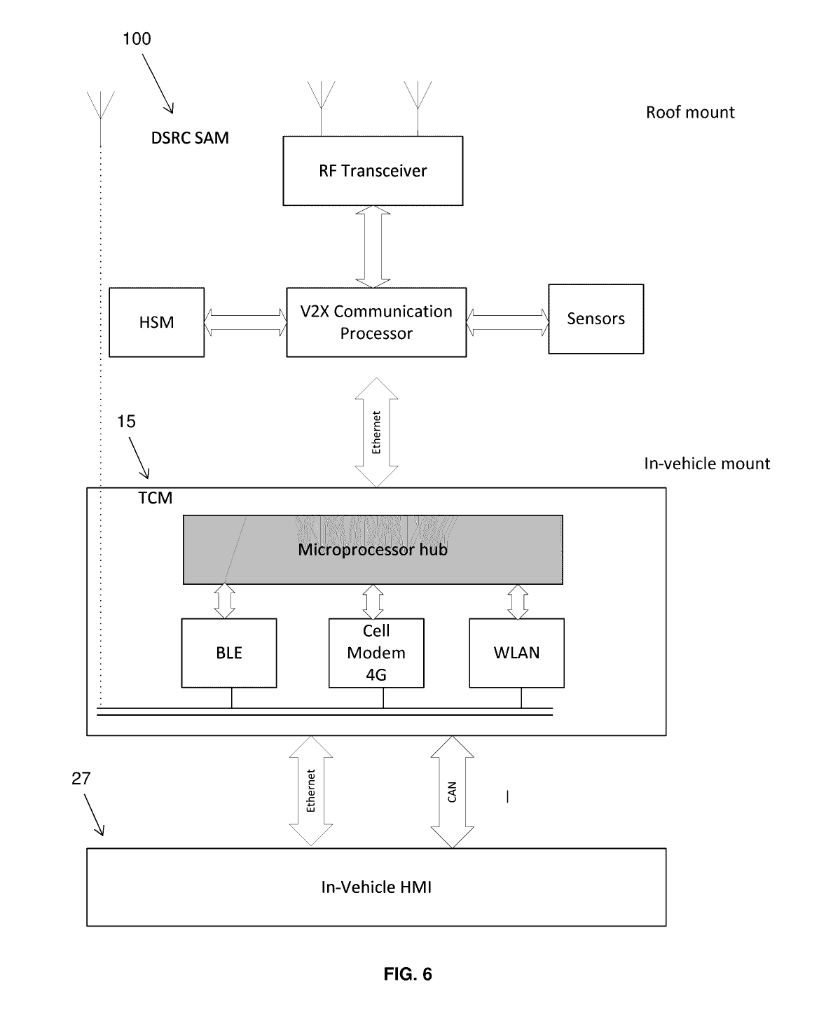

The TCM or in-vehicle connectivity module is generally a data pipe module configured to provide a digital communication pipe to the vehicle. The TCM is configured to provide wireless connectivity and internet browsing capability to passengers in the vehicle. Components of the TCM may generally include a microprocessor or microcontroller, a modem (e.g., LTE 4G modem, etc.), a Wi-Fi module, a Bluetooth/Bluetooth low energy (BT/BLE) module, and Ethernet interface(s). The microprocessor or microcontroller is generally configured to process data received from the SAM. The TCM may relay DSRC related digital information from the SAM to the vehicle's HMI (human machine interface) system via Wi-Fi and/or Ethernet (e.g., FIG. 6, etc.). The Ethernet interface may be configured to communicate data between the smart antenna module (SAM) and the in-vehicle connectivity module or telematics communications module (TCM). By way of example, the HMI system may use a visible warning on a display and/or an audible warning (e.g., a chime, buzzer, etc.) depending on the digital information it received.

In some exemplary embodiments, the SAM is a shark-fin based smart antenna assembly, which includes or houses one or more LTE MIMO antennas, a satellite radio antenna, and a fully integrated DSRC system with GPS receiver and their respective antennas. The TCM may be a black box (e.g., 5 inches by 5 inches, etc.) that houses the LTE modem, Wi-Fi and Bluetooth system with a microcontroller and Ethernet interfaces.

By way of example, the V2X smart antenna assembly may be mounted on top of a vehicle's roof. The in-vehicle connectivity module or TCM may be mounted inside the vehicle under the roof below the SAM. As shown for example in FIG. 1, the V2X smart antenna assembly 100 may thus reside on top of the roof, while the TCM 15 sits underneath the roof below the V2X smart antenna assembly 100.

In some exemplary embodiments, there is a DSRC smart antenna assembly that is similar (e.g., in appearance, size, and shape, etc.) to a LTE/MIMO shark fin antenna assembly from the outside. But in addition to having antennas for cellular, GNSS, and satellite radio, there is also electronic circuitry to allow the V2X system to communicate with other V2X systems using DSRC (Dedicated Short Range Communications) that operates at 5.9 GHz frequency. DSRC is based on the 802.11p and WAVE (US standard) or ETSI (EU standard). DSRC may be used for vehicle to vehicle communication (V2V), communication to other DSRC transceivers in other vehicles, etc.

With reference now to the drawings, FIG. 1 illustrates an example embodiment of a V2X antenna system 11. As shown in FIG. 1, the V2X antenna system 11 includes a telematics communication module (TCM) 15 and a smart antenna module (SAM) 100. The smart antenna assembly 100 may be mounted on top of a vehicle's roof. The telematics communication module 15 may be mounted inside the vehicle.

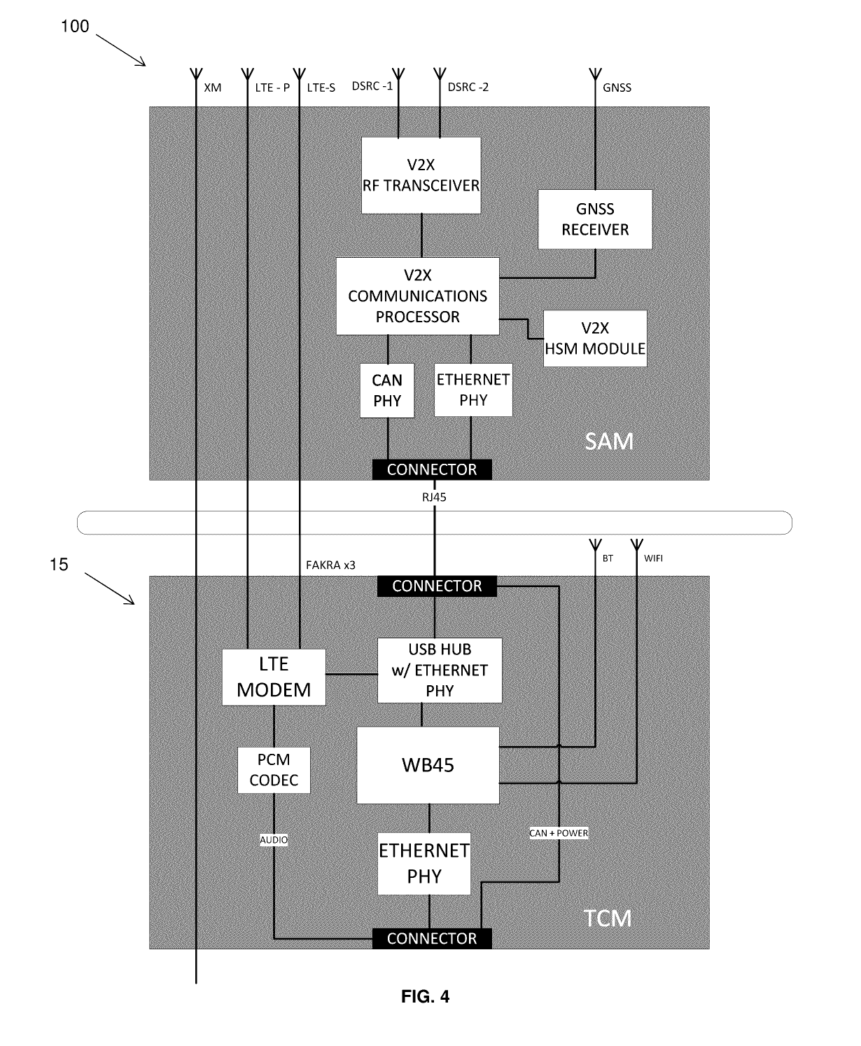

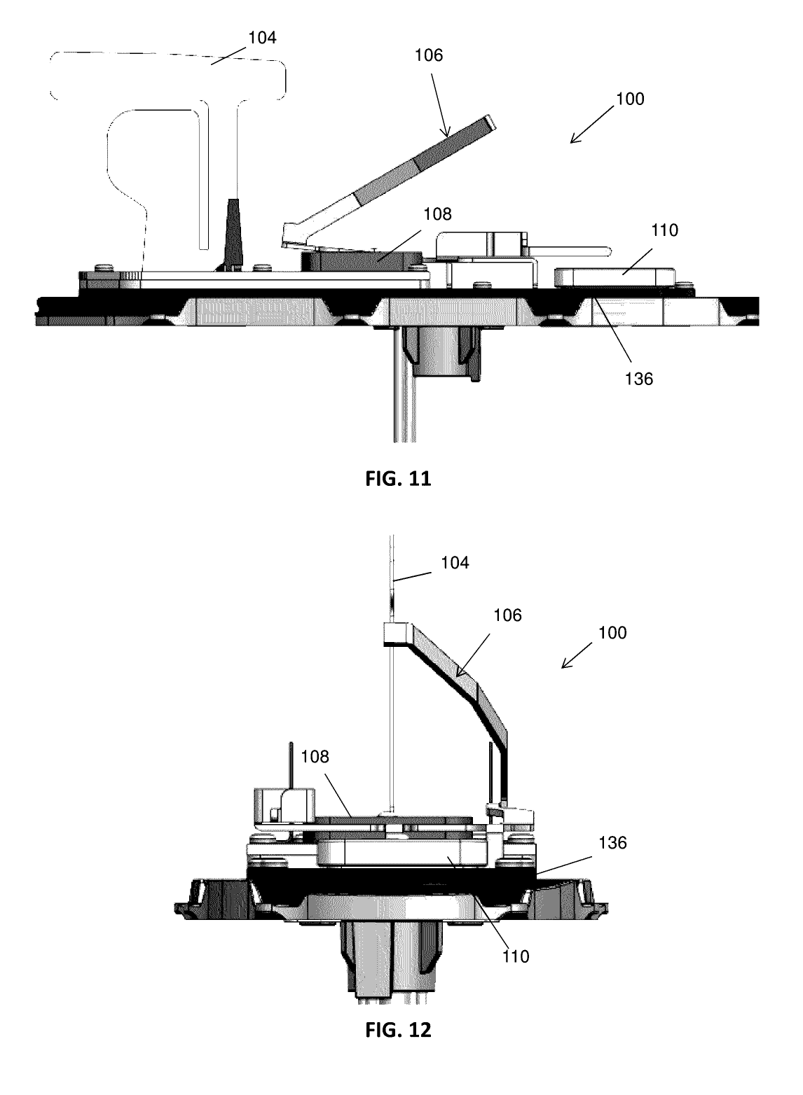

The smart antenna assembly 100 is also shown in FIGS. 9 through 13 without the radome 130. As shown in FIG. 9, the smart antenna assembly 100 includes a first or primary cellular antenna 104, a second or secondary cellular antenna 106, a first patch antenna 108, and a second patch antenna 110, and a DSRC antenna 112. In FIG. 4, the primary cellular antenna 104 corresponds to LTE-P, the secondary cellular antenna 106 corresponds to LTE-S, the first patch antenna 108 corresponds to GNSS, the second patch antenna 110 corresponds to XM, and the DSRC antenna elements 116 and 118 correspond respectively to DSRC-1 and DSRC-2.

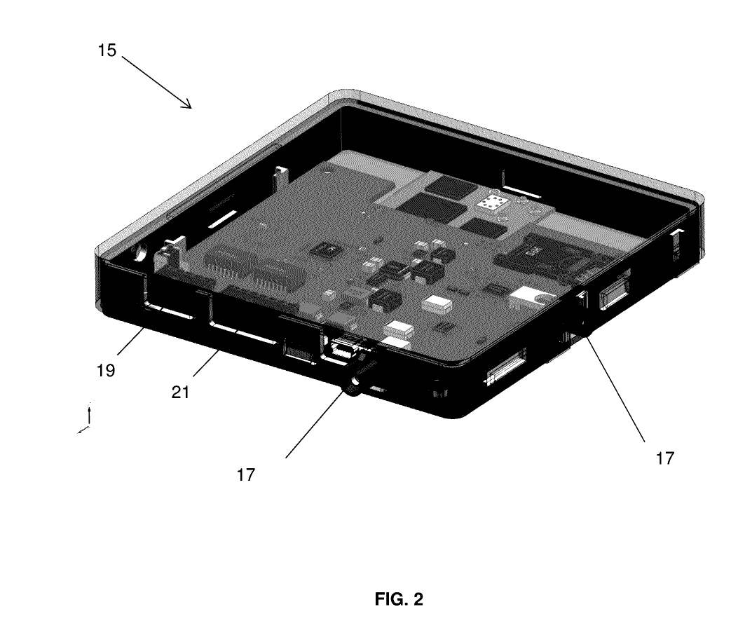

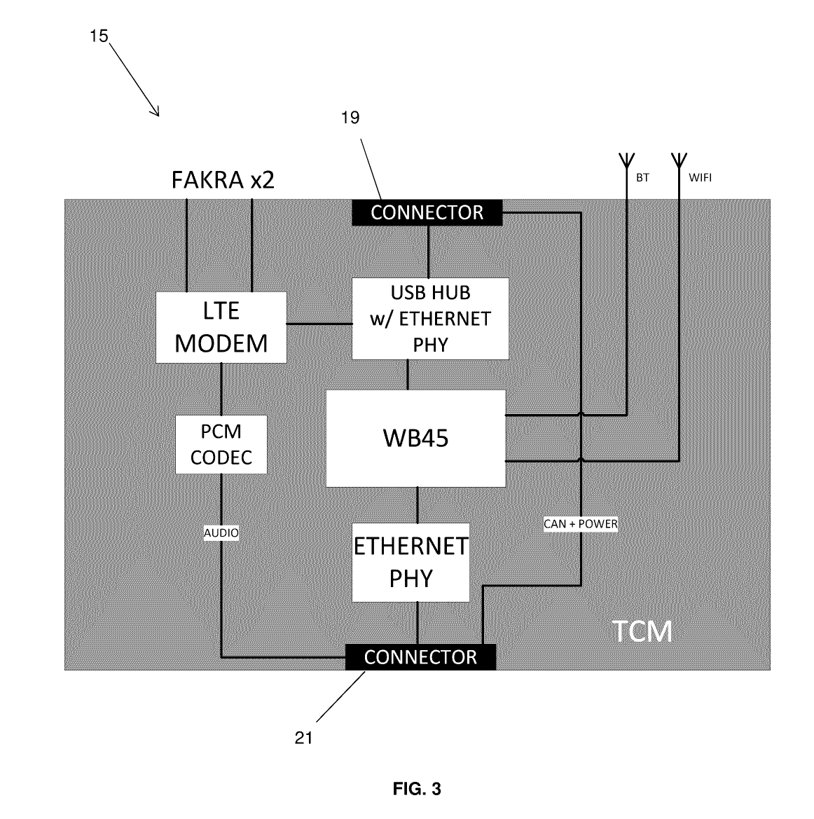

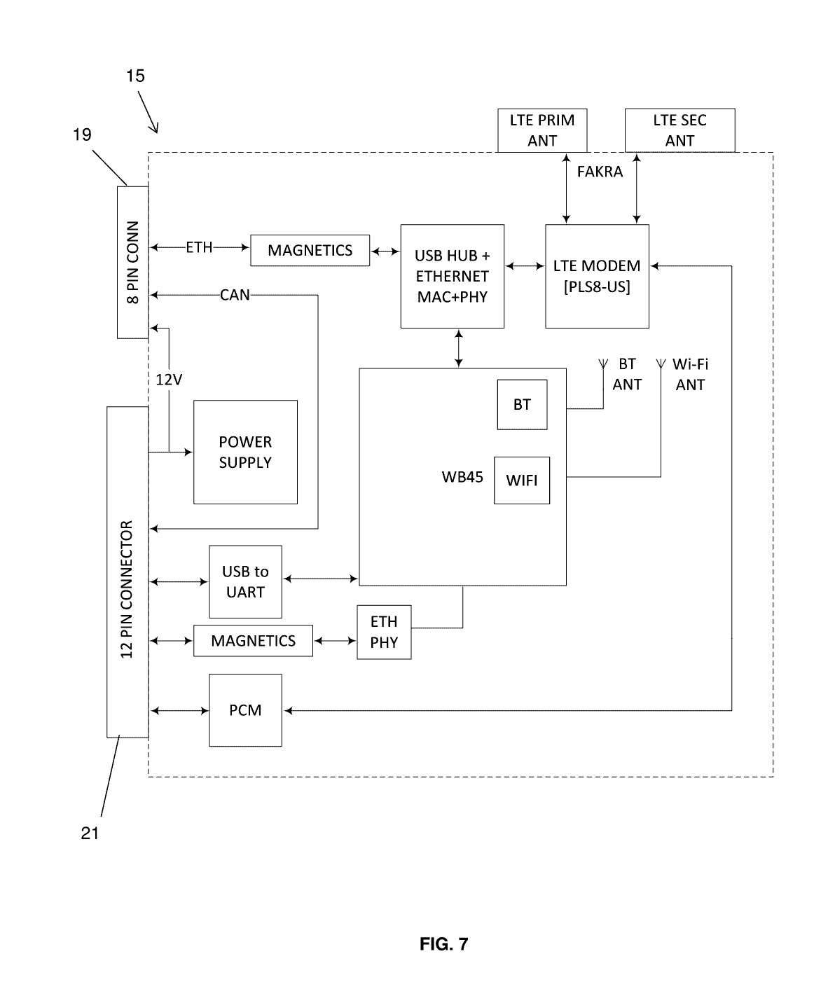

The telematics communication module (TCM) 15 is also shown in FIG. 2. Components of the telematics communication module 15 are shown in FIGS. 3 through 7. More specifically, FIG. 3 is a block diagram showing components of the telematics communication module 15. As shown in FIGS. 2 and 3, the telematics communication module 15 comprises a FAKRA connectors 17 for connecting to the primary cellular antenna 104 (LTE-P) and the secondary cellular antenna 106 (LTE-P) as shown in FIGS. 4 and 7. The telematics communication module 15 also includes an 8-pin RJ45 connector 19 (FIGS. 2 and 4) for connecting to a corresponding 8-pin RJ45 connector of the antenna assembly 100 (FIGS. 4 and 7). The telematics communication module 15 also includes a 12-pin connector 21 (FIGS. 2 and 7).

With continued reference to FIG. 3, the telematics communication module 15 also includes an Ethernet physical layer (ETHERNET PHY) coupled to, linked between, and/or in communication with the connector 21 and a wireless bridge module and/or wireless communications subsystem (WB45). The wireless bridge module (WB45) is coupled to, linked between, and/or in communication with a Bluetooth (BT) antenna and a Wi-Fi antenna. By way of example, the wireless bridge module (WB45) may comprise a Laird WB45NBT wireless bridge communications subsystem, which may be used as both a wireless bridge and as a wireless communications subsystem. Alternatively, the wireless bridge module and/or wireless communications subsystem (WB45) may comprise other suitable wireless bridge communications subsystems in other embodiments.

A USB HUB with an Ethernet physical layer (PHY) is coupled to, linked between, and/or in communication with the connector 19 and the wireless bridge module (WB45). An LTE modem is coupled to, linked between, and/or in communication with two FAKRA connectors, the USB HUB w/ETHERNET PHY, and Pulse Code Modulation Audio Codec (PCM CODEC). The PCM CODEC is coupled to, linked between, and/or in communication with the LTE modem and the connector 21.

As shown in FIG. 4, the telematics communication module (TCM) 15 and smart antenna module (SAM) 100 may be positioned along opposite interior and exterior sides of a vehicle roof. The connector 19 of the telematics communication module 15 is coupled to, linked between, and/or in communication with a connector of the smart antenna module 100.

With continued reference to FIG. 4, the smart antenna module 100 includes a CAN PHY (controller area network physical layer) coupled to, linked between, and/or in communication with a V2X communications processor and the RJ45 connector. An Ethernet PHY is also shown coupled to, linked between, and/or in communication with V2X communications processor and the RJ45 connector. The V2X communication processor is also coupled to, linked with, and/or in communication with a V2X RF transceiver, a GNSS receiver, and a V2X hardware security module (HSM). The V2X RF transceiver is coupled to and/or linked with the DSRC antenna elements 116 and 118 (FIG. 9), which are identified as DSRC-1 and DSRC-2 in FIG. 4. The GNSS receiver is coupled to and/or linked with the first patch antenna 108 (FIG. 9), which is identified as GNSS in FIG. 4.

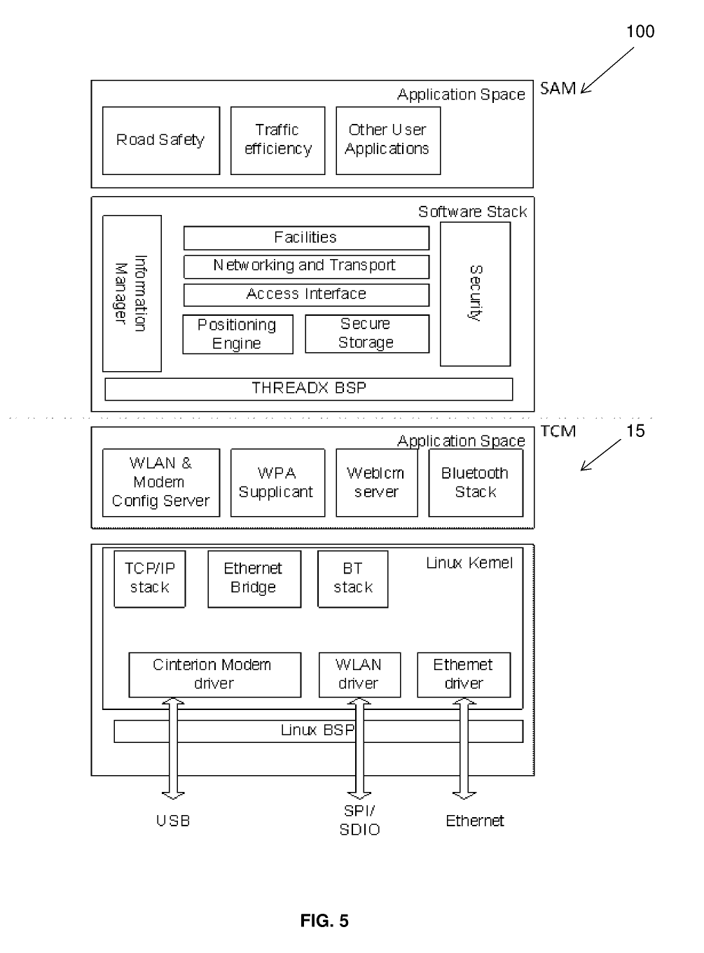

FIG. 5 is a software architecture block diagram of the telematics communication module (TCM) 15 and the smart antenna module (SAM) 100. As shown, the Application Space for the SAM 100 includes road safety, traffic efficiency, and other user applications. The Software Stack for the SAM 100 includes an Information Manager, Positioning Engine, Secure Storage, Security, Facilities, Networking and Transport, Access Interface, and an board support package (BSP) (e.g., ThreadX (real-time operating system) BSP, etc.).

The Application Space for the TCM 15 includes WLAN & Modem Config Server, WPA Supplicant, Weblcm Server, and Bluetooth Stack. The Weblcm Server is a web server that runs on the wireless bridge communications subsystem (WB45). The Weblcm Server is a browser application that provides useful logging, system configuration and troubleshooting tools. The Software Stack for the TCM 15 includes a Linux Kernel and a Linux board support package (BSP). The Linux Kernel includes a Transmission Control Protocol/Internet Protocol (TCP/IP) Stack, Ethernet Bridge, Bluetooth Stack, Criterion Modem driver, WLAN driver, and Ethernet driver. Bi-directional communication links are shown between the Criterion Modem driver and a USB port, between the WLAN driver and a serial peripheral interface/secure digital input output (SPI/SDIO), and between the Ethernet driver and an Ethernet port.

FIG. 6 is a hardware block diagram of the telematics communication module (TCM) 15 and the smart antenna module (SAM) 100. As shown, the SAM 100 includes an RF transceiver coupled to and/or linked with DSRC antenna elements (see 116 and 118 in FIG. 9 and DSRC-1 and DSRC-2 in FIG. 4). FIG. 6 also shows a V2X communications processor coupled to, linked between, and/or in communication with the RF transceiver, a hardware security module (HSM), and sensors. For example, the V2X communications processor may be connected to the vehicle's CAN (controller area network), which can access the wheel tick sensors, gyroscope, tachometer, odometer, TPMS (tire pressure monitoring system), etc.

The SAM 100 is coupled to, linked with, and/or in communication with the TCM 15 via Ethernet. The TCM 15 includes a microprocessor hub, a cellular modem (e.g., LTE 4G modem, etc.), a Bluetooth low energy (BLE) system, and wireless local area network (WLAN). The TCM 15 is coupled to, linked with, and/or in communication with the in-vehicle HMI (human machine interface) 27. The TCM 15 may relay DSRC related digital information from the SAM 100 to the vehicle's HMI 27 via Ethernet and/or CAN (controller area network).

FIG. 7 is a block diagram showing components of the telematics communication module (TCM) 15. As shown, the TCM 15 includes an LTE modem (e.g., PLS8-US, etc.) coupled to, linked with, and/or in communication with primary and second LTE antennas (LTE PRIM ANT and LTE SEC ANT) via FAKRA connectors. The LTE modem is also shown coupled to, linked with, and/or in communication with PCM (Pulse Code Modulation) and a USB HUB with Ethernet MAC (media access control) and PHY (physical layer).

The USB HUB is coupled to, linked with, and/or in communication with a wireless bridge module and/or wireless communication subsystem (WB45), which may comprise a WB45NBT wireless bridge module from Laird, etc. The wireless bridge module (WB45) includes Bluetooth (BT) and Wi-Fi modules, respectively, coupled to, linked with, and/or in communication with Bluetooth (BT) and Wi-Fi antennas. The wireless bridge module (WB45) is also shown coupled to, linked with, and/or in communication with a USB to UART bridge controller or converter and an Ethernet physical layer (ETH PHY). The USB to UART bridge may be used for debugging although the USB to UART bridge is not necessarily required and may be removed such as if debugging is not required.

The 8-pin connecter 19 is shown connected to magnetics via Ethernet (ETH). The CAN (controller area network) couples or links the 8-pin connector 19 and the 12-pin connector 21. The connectors 19 and 21 are also connected to the power supply. The 12-pin connecter 21 is further connected to magnetics, the USB to UART bridge controller or converter, and the PCM (Pulse Code Modulation).

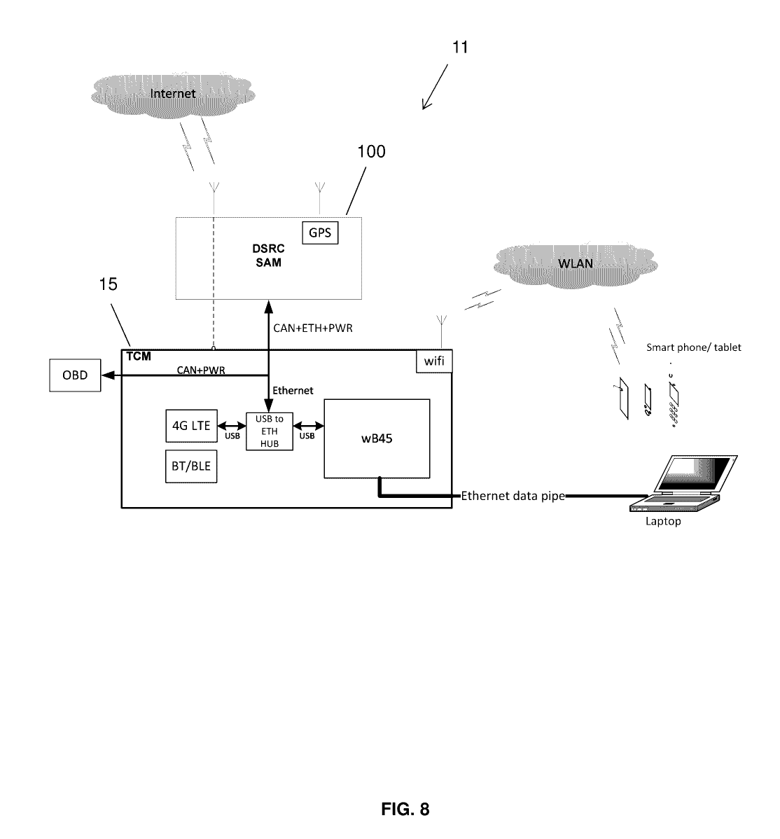

FIG. 8 is a diagram showing an example use of the V2X antenna system 11 including the telematics communication module (TCM) 15 and smart antenna module (SAM) 100. The TCM 15 may be operable as an in-vehicle connectivity module that provide a digital communication pipe (e.g., Ethernet data pipe to a laptop computer, etc.), wireless connectivity (e.g., WLAN including a Wi-Fi antenna and smart phones, tablets, etc.), and internet browsing capability to passengers in the vehicle. The TCM 15 may also be coupled to, linked with, and/or in communication with the vehicle's on-board diagnostics (OBD).

As shown in FIG. 8, the TCM 15 may generally include a wireless bridge module and/or wireless communication subsystem (WB45), a USB to Ethernet (ETH) hub, a modem (e.g., 4G LTE modem, etc.), a Bluetooth/Bluetooth low energy (BT/BLE) module, and Ethernet interface(s), a Wi-Fi module, and a Wi-Fi antenna.

FIG. 14 is a block diagram showing exemplary system components 160 that may be used with or included within the smart antenna module or assembly 100 shown in FIGS. 9 through 13. In this example, power circuitry is shown connected to a power supply (e.g., 12V DC power supply, etc.). A CAN PHY (controller area network physical layer) is shown coupled to, linked with, and/or in communication with the vehicle CAN bus. The vehicle CAN bus is a standard that allows microcontrollers and devices to communicate with each other in applications without a host computer.

An Ethernet PHY is shown coupled to, linked with, and/or in communication with the vehicle Ethernet. The Ethernet PHY may operate as a physical layer and implement hardware send and receive functions. Accordingly, the system has Ethernet and CAN interfaces that may be used to communicate with other systems in the vehicle. By way of example, the system may obtain sensor data over the CAN bus, such as a gyro/accelerometer data, data from wheel tick sensors, etc.

FIG. 14 also shows a communication processor (e.g., CRATON ATK4100 V2X communication process, etc.) coupled to, linked with, and/or in communication with the Ethernet PHY and the CAN PHY. The communication processor is also shown coupled to, linked with, and/or in communication with DBG TP via RS-232, which is a standard for serial communication transmission of data. DGB TP may be used for debug communication although DGB TP is not necessarily required and may be removed such as if debugging is not required.

The communication processor is coupled to, linked with, and/or in communication with one or more memory chips or storage mediums (e.g., DDR3 128 MB Double Data Rate Type 3 Random Access memory, NOR Flash 4MB flash memory, etc.) in which to store configuration and other data and information. The communication processor is further coupled to, linked with, and/or in communication with a microcontroller (e.g., solid flash SLE 97 smartcard microcontroller, etc.) and a receiver/transmitter (Rx/Tx) module (e.g., PLUTON ATK310080 V2X radio frequency (RF) transceiver for V2V and V2I, etc.). By way of example, NOR flash may be used to store the device firmware while DDR3 memory may be used as RAM (random access memory) while the OS (operating system)is running. It may be used as a scratch pad/swap space/cache for quick data access.

The Rx/Tx module is coupled to, linked with, and/or in communication with the RF Front End. Generally, the RF Front End includes the radio receiver circuitry between the C2X (Car-to-X) antennas and the Rx/Tx module. The RF Front End may include components that process the signals at the original incoming radio frequency (RF). The RF Front End may include an impedance matching circuit, a band pass filter, and/or an RF amplifier.

FIG. 14 also shows a global navigation satellite system (GNSS) receiver (e.g., Tesseo II GNSS Receiver, etc.). The receiver is linked to or in communication with a GNSS antenna (e.g., patch antenna 108 in FIG. 9, etc.) for receiving satellite navigation signals from the GNSS antenna. The GNSS receiver is coupled to, linked with, and/or in communication with the communication processor to determine vehicle location.

By way of example, the system shown in FIG. 14 may be used with road toll systems. Also by way of example, the system may also use the speed of the vehicle and distance travelled by the vehicle to validate position tracking information received by the GNSS (e.g., GPS, etc.) receiver. But if the GPS satellites are not available, vehicle location may, for example, be determined by tracking from last known position and then varying based on other data, such as speed, gyro, wheel ticks, etc.

As shown in FIGS. 9 through 13, the smart antenna assembly or module 100 includes a first or primary cellular antenna 104, a second or secondary cellular antenna 106, a first patch antenna 108, and a second patch antenna 110, and a DSRC antenna 112. The antenna assembly 100 may be used with the telematics communication module 15 shown in FIGS. 1 through 8 and/or the V2X antenna system shown in FIG. 14.

As shown in FIG. 9, the DSRC antenna 112 comprises a DSRC board 114 and first and second antenna elements 116, 118. The antenna elements 116, 118 are spaced apart from each other and disposed along opposite sides of the first cellular antenna 104, whereby the antenna elements 116, 118 provide an array effect for omnidirectionality in the pattern. The DSRC board 114 includes generally a planar surface having an opening or recess 120 configured (e.g., defined, sized, shaped, located, etc.) to allow the first cellular antenna 104 to be positioned at least partially therethrough.

A main printed circuit board (PCB) or substrate 136 is positioned underneath the DSRC antenna 112 and the second patch antenna 110. The cellular antennas 104, 106 and patch antennas 108, 110 are coupled to and/or supported by (e.g., soldered to, etc.) the main PCB 136. The first and second patch antennas 108, 110 include respective connectors (e.g., feed pin, interlayer connector, etc.) extending therethrough which may be soldered, etc. to the main PCB 136. In this example, the patch antennas 108, 110 are spaced apart from each other and located one on the DSRC board 114 and one on the main PCB 136. Alternatively, the patch antennas 108, 110 may be disposed adjacent or side-by-side in the front portion of the antenna assembly 100. Yet alternatively, the patch antennas 108, 110 may be positioned at other locations, e.g., stacked on top of each other, etc.

The DSRC antenna 112 (e.g., DSRC elements 116, 118, board 114, etc.) is coupled to and/or supported by the main PCB 136. For example, the board 114 may comprise an electrically conductive trace (broadly, an electrical conductor) along the main PCB 136. The DSRC antenna elements 116, 118 may be soldered to a portion of the DSRC board 114 for electrical connection to a feed network.

In this example, the main PCB 136 may comprise FR4 glass-reinforced epoxy laminate, which tends to be very lossy at high frequencies. The DSRC board 114 may comprise a material more compatible with high frequencies, such as the 5.9 MHz band associated with DSRC, etc. By way of example, the DSRC board 114 may comprise a woven fiberglass polytetrafluoroethylene (PTFE) composite material or any low-loss tangent high frequency substrate. In one exemplary embodiment, the DSRC board 114 comprises Arlon Diclad 880 PTFE/woven fiberglass laminate, which has a low fiberglass/PTFE ratio, low dielectric constant and dissipation factor, and a relative permittivity of 2.17 or 2.20. In another exemplary embodiment, the DSRC board 114 comprises TLP-5-0310-CLH/CLH woven matrix of fiberglass fabric coated with PTFE from Taconic, which has a low dielectric constant of about 2.2.

The first or primary cellular antenna 104 is configured to be operable for both receiving and transmitting communication signals within one or more cellular frequency bands (e.g., Long Term Evolution (LTE), etc.). In addition, the first cellular antenna 104 may also be configured to be operable with the amplitude modulation (AM) band and the frequency modulation (FM) band and/or to be connected with an AM/FM antenna mast via an opening in a radome and electrical contact clip. Alternative embodiments may include a first cellular antenna that is configured differently, e.g., a stamped metal wide band monopole antenna mast, etc. The first cellular antenna 104 may have one or more bent or formed tabs at the bottom, which may provide areas for soldering the first cellular antenna 104 to the main PCB 136 through the opening 120 defined by the DSRC board 114. The first cellular antenna 104 may also include a downwardly extending projection that may be at least partially received within a corresponding opening in the main PCB 136, for example, to make electrical connections to a component on the opposite side of the main PCB 136. Alternatively, other embodiments may include other means for soldering or connecting the first cellular antenna 104 to the main PCB 136.

The second or secondary cellular antenna 106 is configured to be operable for receiving (but not transmitting) communication signals within one or more cellular frequency bands (e.g., LTE, etc.). In alternative embodiments, the second cellular antenna 106 may be configured to transmit in a different channel (Dual Channel feature) or transmit at the same channel but at a different time slot (Tx Diversity).

The second cellular antenna 106 may be supported and held in position by a support, which may comprise plastic or other dielectric material. As shown in FIG. 9, the second cellular antenna 106 generally includes first and second element portions 106a, 106b. The first element portion 106a is mounted in a fixed condition by solder to a pattern formed partially on the DSRC board 114 and partially on the main PCB 136. The first element portion 106a may include downwardly extending portions, legs, or shorts 106c, 106d generally perpendicular to the main PCB 136. The legs 106c, 106d are configured to be slotted or extended into holes in the main PCB 136 for connection (e.g., solder, etc.) to a feed network. The second element portion 106b is generally extending upwardly at an acute right angle relative to the planar surface of the DSRC board 114. Alternative embodiments may include a second cellular antenna that is configured differently (e.g., inverted L antenna (ILA), planar inverted F antenna (PIFA), etc.).

The first and second patch antennas 108 and 110 may be configured to be operable for receiving satellite signals. In this illustrated embodiment, the first patch antenna 108 is configured to be operable for receiving GNSS signals (e.g., GPS or GLONASS signals, etc.). The second patch antenna 110 is configured to be operable for receiving DAB or SDARS signals (e.g., Sirius XM, etc.). In exemplary embodiments, the DAB or SDARS signals may be fed via a coaxial cable to the DAB or SDARS radio, which, in turn, may be located in an Instrument Panel (IP) that is independent of the DAB and DSRC receiver boxes.

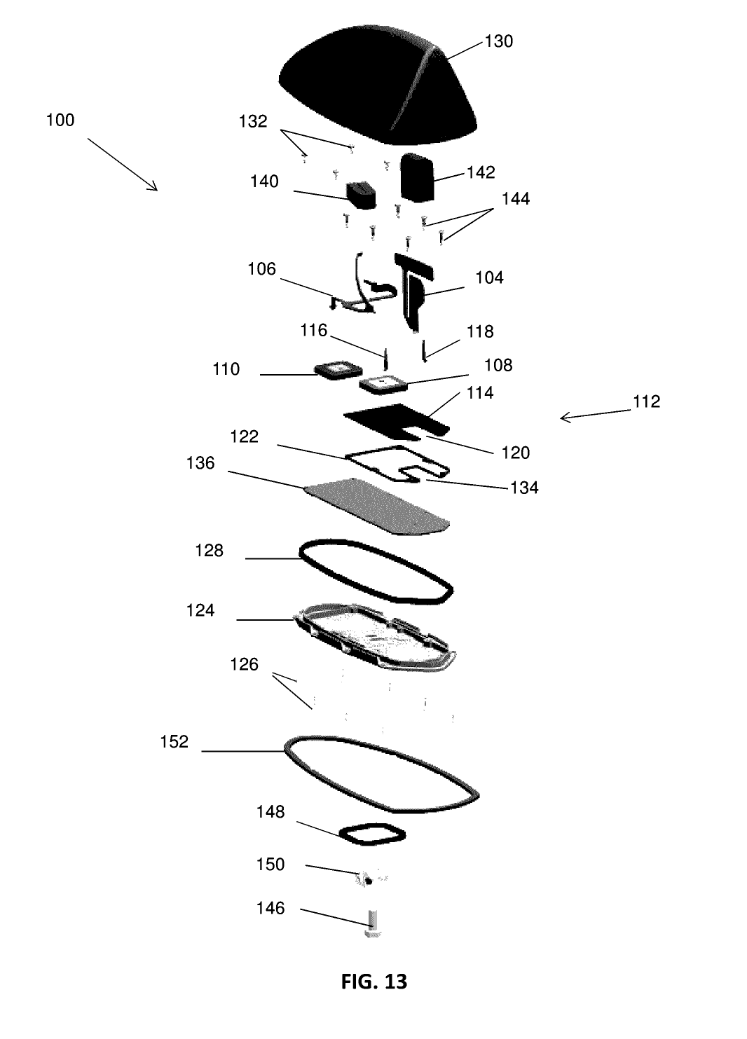

The first and second cellular antennas 104, 106 are connected to and supported by the main PCB 136 and/or the DSRC board 114 by, for example, soldering, etc. A shield 122 (FIG. 13) is inserted between the main PCB 136 and the DSRC board 114 to separate and insulate electrical connections of the conductive traces therebetween. Similarly, the shield 122 defines an opening or recess 134 configured (e.g., defined, sized, shaped, located, etc.) to allow the first cellular antenna 104 to be positioned at least partially therethrough. The opening or recess 134 preferably matches the shape of the opening or recess 120 defined by the DSRC board 114.

The main PCB 136 is supported by the chassis, base, or body 124. In this example embodiment, the main PCB 136 is mechanically fastened via fasteners 132 and 144 (e.g., flat head screws, etc.) to the chassis 124. The fasteners 144 may also mechanically fasten the DSRC board 114 and shield 122 to the main PCB 136.

In some exemplary embodiments, the antenna assembly 100 may include gaskets coupled to the bottom of the chassis 124 to help ensure that the chassis 124 will be grounded to a vehicle roof and also allow the antenna assembly 100 to be used with different roof curvatures. The gaskets may include electrically-conductive fingers (e.g., metallic or metal spring fingers, etc.). In an exemplary embodiment, the gaskets comprise fingerstock gaskets from Laird.

The antenna assembly 100 also includes a radome or cover 130 (FIG. 13). The cover 130 is configured to fit over the first and second cellular antennas 104, 106, the first and second patch antennas 108, 110, and the DSRC antenna 112, such that the antennas 104, 106, 108, 110, 112 are disposed or co-located under the cover 130.

The cover 130 is configured to protect the relatively fragile antenna elements from damage due to environmental conditions such as vibration or shock during use. Foam pads 140, 142 may be placed between the cover 130 and the first and second cellular antennas 104, 106. As shown, the foam pads 140, 142 include slits for receiving portions of the respective first and second cellular antennas 104, 106 to attached and hold the foam pads 140, 142 in place, e.g., via a friction or interference fit, etc.

The cover 130 is configured to be secured to the chassis 124. In this illustrated embodiment, the cover 130 is secured to the chassis 124 by mechanical fasteners 126 (e.g., screws, etc.). Alternatively, the cover 130 may secure to the chassis 124 via any suitable operation, for example, a snap fit connection, mechanical fasteners (e.g., screws, other fastening devices, etc.), ultrasonic welding, solvent welding, heat staking, latching, bayonet connections, hook connections, integrated fastening features, etc.

The chassis or base 124 may be configured to couple to a roof of a car for installing the antenna assembly 100 to the car. For example, the antenna assembly 100 may be mounted to an automobile roof, hood, trunk (e.g., with an unobstructed view overhead or toward the zenith, etc.) where the mounting surface of the automobile acts as a ground plane for the antenna assembly 100 and improves reception of signals. The relatively large size of the ground plane (e.g., a car roof, etc.) may improve reception of radio signals having generally lower frequencies. Alternatively, the cover 130 may connect directly to the roof of a car within the scope of the present disclosure.

The antenna assembly 100 may include a fastener member 146 (e.g., threaded mounting bolt having a hexagonal head, etc.) and a retention component 150 (e.g., an insulator and/or retaining clip, etc.). The fastener member 146 and retention component 150 may be used to mount the antenna assembly 100 to an automobile roof, hood, or trunk (e.g., with an unobstructed view overhead or toward the zenith, etc.). As such, the antenna assembly 100 can be installed and fixedly mounted to the automobile body wall (e.g., roof, hood, trunk, etc.) after a portion of the fastener member 146 and retention component 150 are inserted into a mounting hole on the automobile body wall (e.g., roof, hood, trunk, etc.) from the external side of the automobile, such that the such that the chassis 124 is disposed on the external side of the vehicle body wall and the fastener member 146 is accessible from inside the vehicle. In this stage of the installation process, the antenna assembly 100 may thus be held in place relative to the vehicle body wall in a first installed position. Then, the antenna assembly 100 may then be nipped or secured to the vehicle body wall by rotating the fastener member 146 from the interior side of the automobile body wall (e.g., roof, hood, trunk, etc.).

The antenna assembly 100 may also include a sealing member 128 (e.g., an O-ring, a resiliently compressible elastomeric or foam gasket, caulk, adhesives, other suitable packing or sealing members, etc.) that is positioned between the radome 130 and the chassis 124 for substantially sealing the radome 130 against the chassis 124. The sealing member 128 may be at least partially seated within a groove defined along or by the chassis 124. There may also be sealing members positioned between the radome 130 and the roof of the car (or other mounting surface), which sealing members may be operable as seals against dust, etc. and as a shield support. For example, the sealing members 148 and 152 (e.g., an O-ring, a resiliently compressible elastomeric or foam gasket, a PORON microcellular urethane foam gasket, etc.) may be positioned between the chassis 124 and the roof of a car (or other mounting surface). The sealing member 152 may substantially seal the chassis 124 against the roof. The sealing member 148 may substantially seal the mounting hole in the roof. In some embodiments, sealing may be achieved by one or more integral sealing features rather than with a separate sealing mechanism.

The antennas 104, 106, 108, 110, 112 are positioned relatively close to each other. The antenna assembly 100 may be configured such that there is sufficient de-correlation (e.g., a correlation less than about 25 percent, etc.), sufficiently low coupling, and sufficient isolation (e.g., at least about 15 decibels, etc.) among the antennas 104, 106, 108, 110, 112. Preferably, the antennas 104, 106, 108, 110, 112 are sufficiently de-correlated to allow the antennas 104, 106, 108, 110, 112 to be positioned relatively close to each other and without appreciably degrading performance of these antennas.

The radome 130 may be formed from a wide range of materials, such as, for example, polymers, urethanes, plastic materials (e.g., polycarbonate blends, Polycarbonate-Acrylnitril-Butadien-Styrol-Copolymer (PC/ABS) blend, etc.), glass-reinforced plastic materials, synthetic resin materials, thermoplastic materials (e.g., GE Plastics Geloy® XP4034 Resin, etc.), etc. within the scope of the present disclosure.

The chassis 124 may be formed from materials similar to those used to form the radome 130. For example, the material of the chassis 124 may be formed from one or more alloys, e.g., zinc alloy, etc. Alternatively, the chassis 124 may be formed from plastic, injection molded from polymer, steel, and other materials (including composites) by a suitable forming process, for example, a die cast process, etc. within the scope of the present disclosure.

Exemplary embodiments of the antenna systems disclosed herein are suitable for V2X communication and may be configured for use as a multiband multiple input multiple output (MIMO) antenna assembly that is operable in multiple frequency bands including the DSRC (Dedicated Short Range Communication) and one or more frequency bandwidths associated with cellular communications, Wi-Fi, satellite signals, and/or terrestrial signals, etc. For example, exemplary embodiments of antenna assemblies disclosed herein may be operable in a DSRC frequency band (e.g., 5.9 GHz band from 5850 MHz to 5925 MHz, etc.) and one or more or any combinations (or all) of the following frequency bands: amplitude modulation (AM), frequency modulation (FM), global navigation satellite system (GNSS) (e.g., global positioning system (GPS), European Galileo system, the Russian GLONASS, the Chinese Beidou navigation system, the Indian IRNSS, etc.), satellite digital audio radio services (SDARS) (e.g., Telematics Control Unit (TCU), Sirius XM Satellite Radio, etc.), AMPS, GSM850, GSM900, PCS, GSM1800, GSM1900, AWS, UMTS, digital audio broadcasting (DAB)-VHF-III, DAB-L, Long Term Evolution (e.g., 4G, 3G, other LTE generation, B17 (LTE), LTE (700 MHz), etc.), Wi-Fi, Wi-Max, PCS, EBS (Educational Broadband Services), WCS (Broadband Wireless Communication Services/Internet Services), cellular frequency bandwidth(s) associated with or unique to a particular one or more geographic regions or countries, one or more frequency bandwidth(s) from Table 1 and/or Table 2 below, etc.

TABLE 1

| | | Lower |
|---|---|---|
| System/Band Description | Upper Frequency (MHz) | Frequency (MHz) |
| 700 MHz Band | 698 | 862 |
| B17 (LTE) | 704 | 787 |
| AMPS/GSM850 | 824 | 894 |
| GSM 900 (E-GSM) | 880 | 960 |
| DCS 1800/GSM1800 | 1710 | 1880 |
| PCS/GSM1900 | 1850 | 1990 |
| W CD MA/UMTS | 1920 | 2170 |
| IEEE 802.11B/G | 2400 | 2500 |
| EBS/BRS | 2496 | 2690 |
| WiIMAX MMDS | 2500 | 2690 |
| W IMAX (3.5 GHz) | 3400 | 3600 |
| PUBLIC SAFETY RADIO | 4940 | 4990 |

TABLE 2

| | |
|---|---|
| | Rx/Downlink |
| Tx/Uplink (MHz) | (MHz) |

| Band | Start | Stop | Start | Stop |
|---|---|---|---|---|
| GSM 850/AMP | 824.00 | 849.00 | 869.00 | 894.00 |
| GSM 900 | 876.00 | 914.80 | 915.40 | 959.80 |
| AWS | 1710.00 | 1755.80 | 2214.00 | 2180.00 |
| GSM 1800 | 1710.20 | 1784.80 | 1805.20 | 1879.80 |
| GSM 1900 | 1850.00 | 1910.00 | 1930.00 | 1990.00 |
| UMTS | 1920.00 | 1980.00 | 2110.00 | 2170.00 |
| LTE | 2010.00 | 2025.00 | 2010.00 | 2025.00 |
| LTE | 2300.00 | 2400.00 | 2300.00 | 2400.00 |
| LTE | 2496.00 | 2690.00 | 2496.00 | 2690.00 |
| LTE | 2545.00 | 2575.00 | 2545.00 | 2575.00 |
| LTE | 2570.00 | 2620.00 | 2570.00 | 2620.00 |

Disclosed herein are exemplary embodiments of V2X smart antenna assemblies. Also disclosed are exemplary embodiments of integrated systems, which may include V2X smart antenna assemblies and in-vehicle connectivity modules with digital communication pipes to vehicles.

Advantageously, exemplary embodiments disclosed herein may provide cost-effective V2X capabilities integration into existing antenna modules (e.g., DSRC system with GPS receiver, LTE MIMO antennas, satellite radio antennas) combined with Wi-Fi and Bluetooth systems having microcontroller and Ethernet interfaces. Exemplary embodiments may offer versatility to customers and car makers, e.g., a customer may be provided the option to integrate DSRC at the dealer level. In exemplary embodiments, a DSRC antenna may be integrated into an existing roof-mount multiband (e.g., quadband with dual-band cellular, GNSS, and SDARS, etc.) antenna assembly such that the existing antenna functionality, styling, footprint or attachment scheme is not affected or required by adding the DSRC functionality.

In addition, various antenna systems or assemblies disclosed herein may be mounted to a wide range of supporting structures, including stationary platforms and mobile platforms. For example, an antenna assembly or system disclosed herein could be mounted to a supporting structure of a bus, train, aircraft, bicycle, motorcycle, boat, among other mobile platforms with a TCM mounted underneath the supporting structure below the antenna assembly. Accordingly, the specific references to vehicles or automobiles herein should not be construed as limiting the scope of the present disclosure to any specific type of supporting structure or environment.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An integrated vehicular antenna system for installation to a body wall of a vehicle, the antenna system comprising:
a V2X smart antenna module including one or more cellular antennas, one or more satellite antennas, and one or more Dedicated Short-Range Communication (DSRC) antennas; and
a telematics communication module including a modem, a Wi-Fi module coupled with a Wi-Fi antenna, and Bluetooth module coupled with a Bluetooth antenna, and one or more Ethernet interfaces for communicating with the V2X smart antenna module;
whereby the antenna system is configured to enable the vehicle to have V2X communications.

2. The antenna system of claim 1, wherein the telematics communication module is configured to be operable to provide a digital communication pipe to the vehicle.

3. The antenna system of claim 1, wherein the telematics communication module is configured to be operable for relaying DSRC related digital information from the V2X smart antenna module to a human machine interface (HMI) within the vehicle via Wi-Fi and/or Ethernet.

4. The antenna system of claim 1, wherein the antenna system is configured to provide internet connectivity via Wi-Fi and/or Ethernet, and Bluetooth based vehicle control and/or monitoring.

5. The antenna system of claim 1, wherein the system is configured to provide Bluetooth and/or Wi-Fi wireless connectivity and internet browsing capability to passengers in the vehicle.

6. The antenna system of claim 1, wherein the V2X smart antenna module and the telematics communication module are configured to be mounted along opposite exterior and interior sides of the body wall of the vehicle.

7. The antenna system of claim 1, wherein the telematics communication module includes a wireless bridge module and/or wireless communication subsystem and a USB hub coupled to the modem and the wireless bridge module and/or wireless communication subsystem.

8. The antenna system of claim 7, wherein:
an Ethernet physical layer component is coupled to the wireless bridge module and/or wireless communication subsystem; and
the wireless bridge module and/or wireless communication subsystem includes the Wi-Fi and Bluetooth modules respectively coupled to the Wi-Fi and Bluetooth antennas.

9. The antenna system of claim 1, wherein the one or more satellite antennas comprise a satellite navigation antenna operable with Global Navigation Satellite System (GNSS) signals, and wherein the V2X smart antenna module comprises:
a V2X RF transceiver coupled to the one or more DSRC antennas; and
a GNSS receiver coupled to the satellite navigation antenna; and
a V2X communications processor coupled to the GNSS receiver and the V2X RF transceiver.

10. The antenna system of claim 9, wherein the V2X smart antenna module comprises:
a V2X hardware security module coupled to the V2X communications processor; and
an Ethernet physical layer component coupled to the V2X communications processor; and
a controller area network physical layer component coupled to the V2X communications processor.

11. The antenna system of claim 1, wherein:
the one or more cellular antennas comprises a first cellular antenna configured to be operable for receiving and transmitting cellular signals, and a second cellular antenna configured to operable for receiving, but not transmitting, cellular signals;
the one or more satellite antennas comprises a satellite navigation antenna configured to be operable with satellite navigation system signals, and a satellite radio antenna configured to be operable with satellite radio signals; and
the one or more DSRC antennas comprises first and second DSRC antenna elements spaced apart from each other.

12. The antenna system of claim 11, wherein:
the first cellular antenna is configured to be operable for receiving and transmitting Long Term Evolution (LTE) signals;
the second cellular antenna is configured to be operable for receiving, but not transmitting, LTE signals;
the satellite navigation antenna is configured to be operable with Global Navigation Satellite System (GNSS) signals; and
the satellite radio antenna is configured to be operable with Satellite Digital Audio Radio Service (SDARS) signals.

13. The antenna system of claim 12, wherein the V2X smart antenna module further comprising at least one antenna configured to be operable with terrestrial signals including one or more of digital audio broadcasting (DAB), amplitude modulation (AM), and/or frequency modulation (FM) signals.

14. A V2X smart antenna assembly for installation to a body wall of a vehicle, the V2X smart antenna assembly comprising:
one or more cellular antennas configured to be operable with cellular signals
one or more satellite antennas including a satellite navigation antenna configured to be operable with satellite navigation system signals, and a satellite radio antenna configured to be operable with satellite radio signals;
one or more Dedicated Short-Range Communication (DSRC) antennas configured to be operable with DSRC signals;
one or more terrestrial antennas configured to be operable with terrestrial signals;
a satellite navigation system receiver coupled to the satellite navigation antenna; and
a V2X RF transceiver coupled to the one or more DSRC antennas.

15. The V2X smart antenna assembly of claim 14, wherein the V2X smart antenna assembly is configured to enable the vehicle to have V2X communication between the vehicle and environment and/or between the vehicle and another vehicle.

16. The V2X smart antenna assembly of claim 14, wherein the one or more cellular antennas, the satellite radio antenna, and the one or more terrestrial antennas are configured with an RF output.

17. The V2X smart antenna assembly of claim 14, wherein:
the one or more cellular antennas are configured to be operable with Long Term Evolution (LTE) signals;
the satellite navigation antenna is configured to be operable with Global Navigation Satellite System (GNSS) signals;
the satellite radio antenna is configured to be operable with Satellite Digital Audio Radio Service (SDARS) signals; and
the one or more terrestrial antennas are configured to be operable with digital audio broadcasting (DAB), amplitude modulation (AM), and frequency modulation (FM) signals.

18. The V2X smart antenna assembly of claim 17, wherein the V2X smart antenna assembly is configured with AM/FM, DAB, LTE, GNSS, and V2X functionalities within the V2X smart antenna assembly.

19. The V2X smart antenna assembly of claim 17, wherein:
the one or more cellular antennas comprise a first cellular antenna configured to be operable for receiving and transmitting LTE signals, and a second cellular antenna configured to be operable for receiving, but not transmitting, LTE signals;
the satellite navigation antenna comprises a first patch antenna; and
the satellite radio antenna comprises a second patch antenna.

20. The V2X smart antenna assembly of claim 19, further comprising a chassis and a radome, wherein the first and second cellular antennas, the first and second patch antennas, the one or more DSRC antennas, the one or more terrestrial antennas, the satellite navigation system receiver, and the V2X RF transceiver are within an interior enclosure defined by the radome and the chassis.
